(19) United States
(12) Patent Application Publication
(10) Pub. No.: US 2026/0007135 A1
(43) Pub. Date: Jan. 8, 2026

(54) USE OF HOP EXTRACTS OR THEIR MIXTURES FOR CONTROL OF GRAM + BACTERIA IN FERMENTATIONS OF MICROORGANISMS IN THE PRODUCTION OF BIOLOGICAL AGENTS FOR AGRICULTURE

(71) Applicants: L N F LATINO AMERICANA CONSULTORIA, ASSESSORIA E IMPORTAÇÃO LTDA, Bento Gonçalves (BR); BETATEC HOP PRODUCTS, INC, Yakima, WA (US)

(72) Inventors: Eduardo Bihre, Lajeado (BR); Sami Faour, Ashburn, VA (US)

(21) Appl. No.: 19/219,230

(22) Filed: May 27, 2025

(30) Foreign Application Priority Data
Jul. 3, 2024 (BR) BR 102024013649-7

(51) Int. Cl. A01N 65/08; A01P 1/00

(52) U.S. Cl. CPC A01N 65/08; A01P 1/00

(57) ABSTRACT

Methods for use of hop acids during the fermentation/multiplication process of microorganisms are disclosed. The process uses hop extracts to control gram+bacteria in fermentation of microorganisms in the production of biological agents for agriculture.

### CROSS-REFERENCE TO RELATED APPLICATIONS

This application claims the benefit of priority to Brazilian Patent Application No. BR 102024013649-7, filed on Jul. 3, 2024, which is hereby incorporated by reference in its entirety.

### FIELD OF INVENTION

The present invention refers to the use of hop acids during the fermentation/multiplication process of microorganisms that will be used as a biological agent in crops.

The term “hop acids,” as used herein, means alpha acids, beta acids, mixtures of these acids, and/or other components found in hop extracts; for example, beta fraction, essential oils, waxes, and uncharacterized resins. The term “hop acids” also includes modified hop acids. Hop alpha acids consist of a mixture of analogues, including humulone, cohumulone, and adhumulone. Alpha acids make-up 10 to 15 percent w/w in dry hops and over 50 percent by weight of carbon dioxide hop extract. During the brewing of beer, hops are boiled and the alpha acids undergo thermal isomerization forming a new compound known as isoalpha acids. Isoalpha acids are the actual bittering and preserving compounds found in beer. Derivatives of isoalpha acids are made by performing simple chemical reductions. These reduced isoalpha acids include rhoisoalpha acids, tetrahydroisoalpha acids (THIAA), and hexahydroisoalpha acids (HHIAA) Thus the term “alpha acids” includes isoalpha acids, tetrahydroisoalpha acids, rhoisoalpha acids, and hexahydroisoalpha acids. Beta acids also consist of a mixture of analogues, including lupulone, colupulone, and adlupulone. The term “beta acids” also includes modified beta acids, such as hexa-hydro-beta acids.

More specifically, the use of hop acids or their mixtures to control gram+ bacteria, in fermentations of multiplication of microorganisms, gram bacteria−or fungi. Bringing efficiency to companies that produce ready-to-use biological products and especially to ON “FARM” multiplications, where we can better control any proliferation of potentially pathological gram+bacteria.

### STATE OF THE ART

Currently, several microorganisms are used as biological agents, both to help fix nutrients in the soil, roots and stems of plants, as well as to attack any insect or pest that may cause damage to the crop. Biological agents completely or partially replace the use of agricultural chemicals.

Several microorganisms are used and each of them has its own multiplication parameters. The microorganisms are multiplied in a submerged fermentation (reactor tanks made of stainless steel, carbon iron or any other material), with abundant injection of air, addition of salts and nutrients and all this material must be previously sterilized and thus added to the fermenter/multiplier.

Companies that produce microorganisms for use in agriculture either do not use any agent to control contaminating bacteria in fermentations, or if they do, they use synthetic antibiotics. As a rule, these antibiotics are products classified as dangerous, carcinogenic and cannot even be added to the soil. Hop acids products are extracted from hop flowers, therefore, natural products and pose no danger to humans or the environment. In addition to companies that produce ready-to-use biological agents, we have a growing market of producers called ON FARM, who multiply their microorganisms on the farm, often without sterilization controls. This is even a very present debate in the current market, whether “ON Farm’ is safe or not. Since other unknown microorganisms can multiply there. But a technological and inventive advantage of using advanced hop extracts will help control undesirable and potentially dangerous gram+microorganisms in fermentations, bringing greater safety to the entire process.

In the current scenario, we have a growing market for the production of biological agents, commonly called bioinputs. The most multiplied microorganisms are gram+bacteria, gram−bacteria and fungi. Each fermentation/multiplication generally aims to multiply only 1 species of microorganism.

When we multiply gram−e bacteria or fungi, contamination of this medium by gram+bacteria is recurrent, notably with a higher multiplication rate. Currently, no type of antibiotic is used that is not harmful to the environment. The most commonly used synthetic antibiotics (penicillin, virginamycin, Tratacycline, monensin, etc.) are, many of them, considered dangerous to human health and carcinogenic. It is common for their use to even be prohibited.

The applicant is a company founded in 1987 and has always worked with biotechnology products, such as enzymes, yeasts, nutrients. Having already been supplying inputs to the bioinputs industry for some years, such as: high-performance defoamers, yeast extracts for nutrition for the multiplication of microorganisms, we were faced with two major needs in the market:
1: there was no type of “antibiotic” that could be used to contain the contamination of microorganisms in fermentations, and that was not a synthetic, carcinogenic, poisonous and dangerous product to both human health and the environment; It is
2: in “ON FARM” multiplications there was always the risk of gram+pathogenic microorganisms multiplying as no type of controller for these microorganisms was used.

The use of hop acid products and their mixtures provides the use of a 100% safe product, from a renewable source and proven efficient against gram+bacteria. This is of great relevance in the multiplications of fungi and gram bacteria.

### Objectives of the Invention

One of the objectives of the present invention is the use of hop acid to control bacteria, as the product is considered natural, renewable and extracted from a plant. Product considered food grade and safe. Furthermore, by using hop acid, we will have a final fermentation, with less gram+contamination, or zero contamination, and no dangerous products were used to obtain this final benefit. In certain embodiments, the hop acid may comprise an alpha acid, beta acid, or a combination of alpha and beta acids. In some embodiments, the hop alpha acid may comprise reduced isoalpha acids. In some embodiments, the hop alpha acid may comprise reduced isoalpha acids including tetrahydroisoalpha acids (THIAA), hexahydroisoalpha acids (HHIAA), or a combination of tetrahydroisoalpha acids (THIAA) and hexahydroisoalpha acids (HHIAA). In another embodiment, the composition may further comprise hop beta acids. In any of the previous embodiments, the composition is any one or more of a liquid, a powder, a colloid, an oil, and an emulsion. In some embodiments, the hop alpha acids are present in an amount from about 1% to about 30% (w/w)

The objective of the present invention is still the possibility of sterilizing the hop alpha acid since it has been proven that their activity remains even after using temperatures of 121° C. for a few minutes. The addition of hop alpha acid or their mixtures will bring security to companies that develop their products ready for use, reducing the incidence of contamination in batches, due to infection with gram+bacteria.

Another objective of using hop alpha acid is to bring greater security to the producer called ON FARM. Since it is known that this producer does not have such great control over contaminants and we know that some gram+bacteria that are in the environment are pathogenic. This is the case of the bacteria Staphylococcus aureus, Listeria monocytogenes, Enterococcus faecalis and Enterococcus faecium, all of which are gram+ bacteria that cause some type of disease in humans and animals and the advanced hop extracts would be preventing or greatly reducing their multiplication there in the ON FARM production.

### BRIEF DESCRIPTION OF THE DRAWINGS

To better understand the components and technical characteristics of the present invention, the attached figures are presented, in which:

FIG. 1 represents an autoclave that can be used to sterilize the hop alpha acids;

FIG. 2 represents another option for sterilization, a gamma radiation sterilization cabin;

FIG. 3 represents a flowchart of the fermentation stage;

FIG. 4 represents a graph with results observed after using the advanced hop extract; and

FIG. 5 represents an example flow chart of a sterilization step.

### DETAILED DESCRIPTION OF THE INVENTION

In order to achieve the objectives proposed above, the use of hop alpha acid of to control bacteria will be described below.

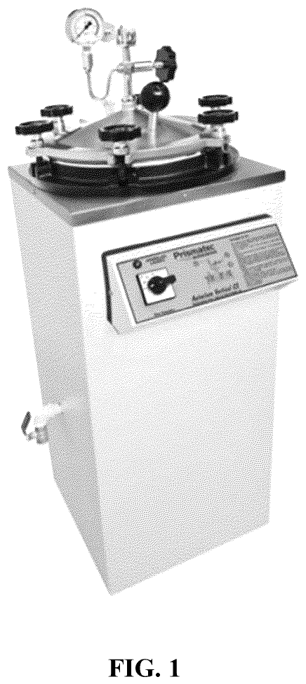

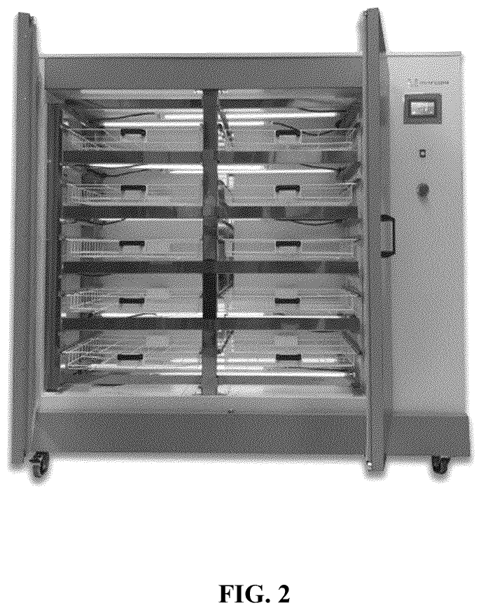

To control gram+contaminating bacteria, the hop alpha acid used may or may not be sterilized. If the option is to sterilize, this must occur in an autoclave or similar where the temperature must be increased to the sterilization range (121° C. is common) and maintained for a few minutes (see FIG. 1). After that, cool it and send the advanced extract to the fermenter, or to the propagator/germinator. The product can also be sterilized by gamma rays in a suitable cabin (see FIG. 2). If sterilization is not carried out, the extracts must be used in their original form (liquid or powder).

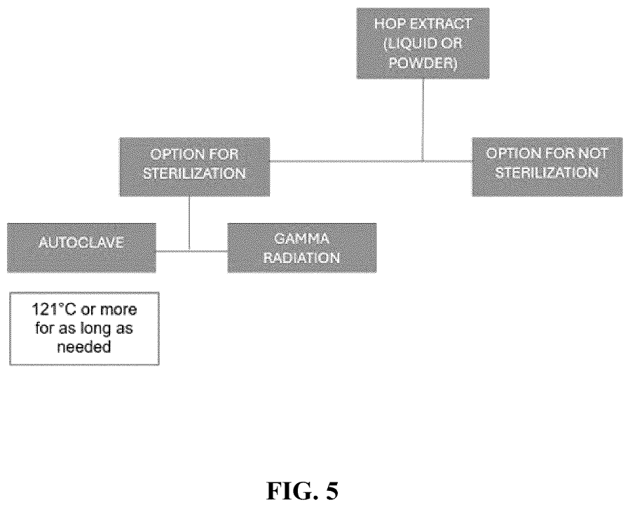

Referring to FIG. 5, one can visualize this sterilization step. After the sterilization process, the product is ready to be sent to the fermenter, together with the nutrients, carbohydrates, salts and water that will be needed for multiplication, as well as the injected compressed air (all this material may have passed through sterilization as well).

Hop alpha acid must be applied in a dosage that varies from 10 to 1,000 ppm in relation to the volume of the fermenter. This dosage varies depending on the severity of the gram+ bacteria infection problem.

If the fermentation project has a germinator/propagator of microorganisms, the hop alpha acid can be added at that point or simultaneously in the fermenter and propagator. The germinator's function is to increase the population of the microorganism that we want to multiply. Not all systems/projects have this stage, some after sterilizing the nutrients, salts, carbohydrates and hop extract go directly to the fermentation stage.

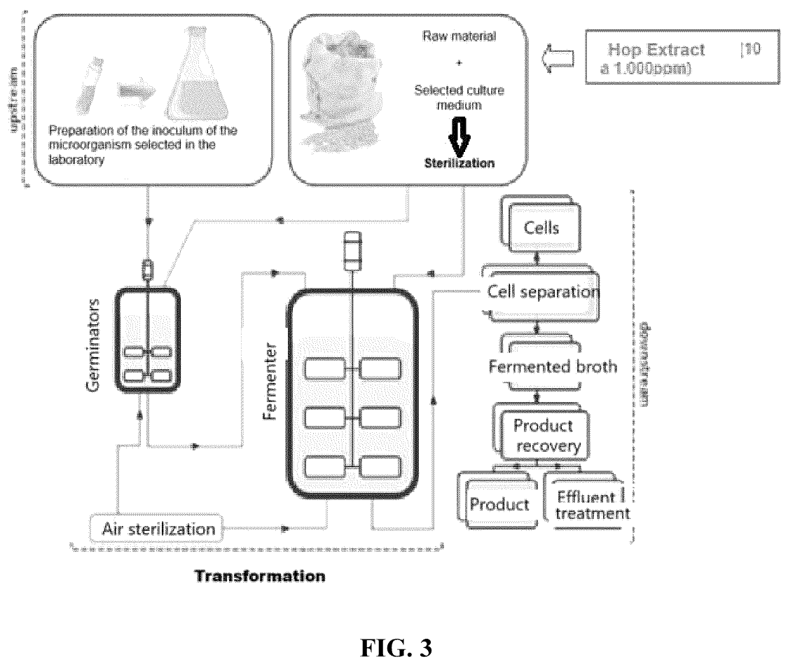

The fermentation stage (see FIG. 3) occurs at the temperatures and times necessary for the multiplication of each organism. Therefore, the extracts will act between 5 to 45° C. and at pHs of 1.5 to 8.0. Table 1, below, shows the best potential of each item at different pHs.

TABLE 1

| | Recommended Products (* this does not mean |
|---|---|
| | that they do not work at other pHs, but they |
| pH range | have their best potential under these conditions) |
| 1.5 to 8.0 | Tetrahydro-iso-alpha-acids, hexahydro-iso- |
| | alpha-acids and iso-alpha-acids |
| 5.5 to 8.0 | Beta-acids |

Fermentation will take place and during this period the hop alpha acid will be active and controlling multiplication and helping to kill any gram+pathogenic or non-pathogenic bacteria that are in the fermentation as a contaminating agent.

The ability to control bacteria was evaluated through work that consisted of evaluating whether the hop alpha acid would in fact not affect the multiplication of fungi and gram bacteria−, this is what was expected by the theory of action of hop extracts in controlling bacteria and whether the extract would kill or control the multiplication of gram+, which in the multiplication of fungi and gram−is a contaminant.

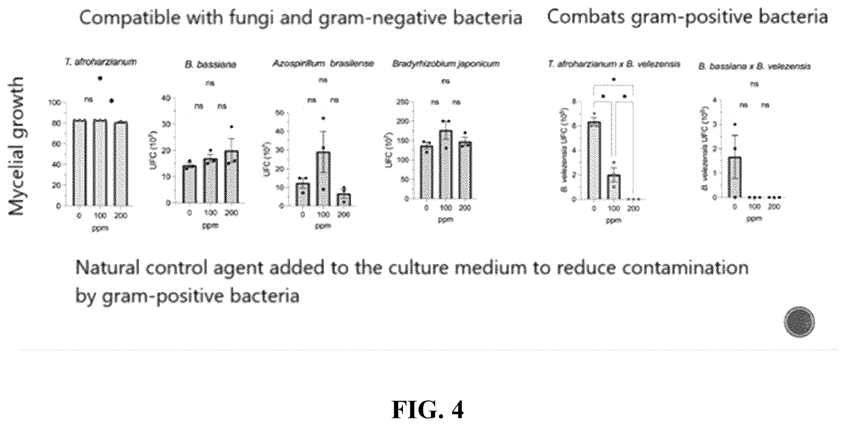

We can see in the graph in FIG. 4 that it is evident that gram bacteria−and fungi are not affected by the addition of FermaHop® Pro in a dosage of 0×100 and 200 ppm, as indicated on the left of the graph. As for the gram+bacteria that were used as contaminants in the system, in the graphs on the right side of FIG. 4, these, as expected, had their population controlled by hop alpha acid.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method comprising:
using advanced hop extracts to control gram+bacteria in fermentations of microorganisms in the production of biological agents for agriculture;
wherein the production of biological agents for agriculture are free of potentially dangerous antibiotics; and
wherein using the advanced hop extracts occurs through the application of different advanced hop extracts, or their mixtures, in dosages that vary from 10 to 1,000 ppm in relation to a volume of a fermenter.

2. The method of claim 1, wherein the control of gram+contaminating bacteria, is performed by using the extracts sterilized, or not, in a form comprising liquid or powder.

3. The method of claim 1, wherein using the advanced hop extract, or mixtures thereof, occurs with advanced hop extracts acting between 5 and 45° C. and at pHs that can vary from 1.5 to 8.0.

4. The method of claim 1, wherein using the advanced hop extract or mixtures thereof in fermentation takes place and during this period the advanced hop extracts become active and control multiplication and help to kill any gram positive bacteria.
